(19) United States
(12) Patent Application Publication
(10) Pub. No.: US 2012/0224936 A1
(43) Pub. Date: Sep. 6, 2012

(54) Nail anchor

(76) Inventor: Tino S. Teng, Taipei (TW)

(21) Appl. No.: 12/932,648

(22) Filed: Mar. 3, 2011

(51) Int. Cl. F16B 21/00

(52) U.S. Cl. 411/511

(57) ABSTRACT

A nail anchor for use with a wall nail for nailing to a hole in a wall of an object is disclosed to include a tubular body having a tapered end portion and a longitudinal split, a plurality of teeth obliquely upwardly and outwardly extended from the periphery of the tubular body for engaging into the periphery of the hole in the wall of the object to prohibit the tubular body from a backward displacement relative to the wall of the object and a plurality of barbed portions obliquely downwardly and inwardly extended from the periphery of the tubular body for engaging into a spiral groove around the periphery of the wall nail to prohibit the wall nail from a backward displacement relative to the tubular body of the nail anchor.

### BACKGROUND OF THE INVENTION

1. Field of the Invention

The present invention relates to a nail anchor for use with a wall nail for nailing to a hole in a wall of a building or construction material, which uses obliquely upwardly and outwardly extending teeth to prohibit the tubular body of the nail anchor from a backward displacement and obliquely downwardly and inwardly extending barbed portions to prohibit the wall nail from a backward displacement relative to the tubular body of the nail anchor.

2. Description of the Related Art

During the construction of a building or construction work, building speed and safety are important. Further, wall nails are intensively used in a building construction to joint materials together or for hanging things. However, a wall nail may fall from the hole in the wall upon a vibration. To enhance installation stability, a wall nail may be used with a nail anchor. Conventional nail anchors are functional; however they are still not perfect in application.

### SUMMARY OF THE INVENTION

The present invention has been accomplished under the circumstances in view. It is one object of the present invention to provide a nail anchor, which secures the installed wall nail firmly in the installed position, prohibiting the wall nail from a backward displacement.

To achieve this and other objects of the present invention, a nail anchor is adapted for use with a wall nail for nailing to a wall of an object, comprising a tubular body having a tapered end portion at a bottom end thereof and a longitudinal split longitudinally extending through top and bottom ends thereof, a plurality of teeth obliquely upwardly and outwardly extended from the periphery of the tubular body and a plurality of barbed portions obliquely downwardly and inwardly extended from the periphery of the tubular body. After installation of the nail anchor with a wall nail in a hole in the wall of a building or construction material, the teeth are engaged into the periphery of the hole in the wall of the building or construction material to prohibit the nail anchor from a backward displacement, and the barbed portions are engaged into a spiral groove around the periphery of the wall nail to prohibit the wall nail from a backward displacement.

### BRIEF DESCRIPTION OF THE DRAWINGS

FIG. 1 is an exploded view of a nail and a nail anchor in accordance with the present invention.

FIG. 2 is a sectional applied view of the present invention.

FIG. 3 is another sectional applied view of the present invention.

### DETAILED DESCRIPTION OF THE PREFERRED EMBODIMENT

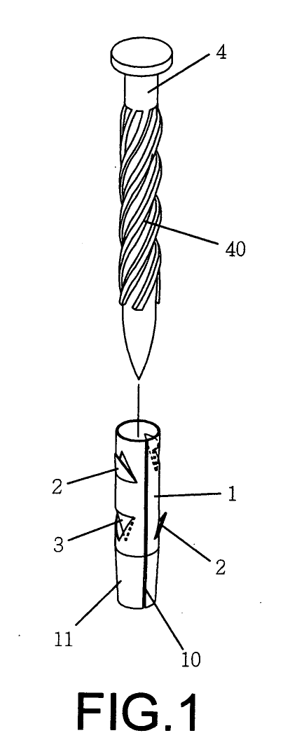

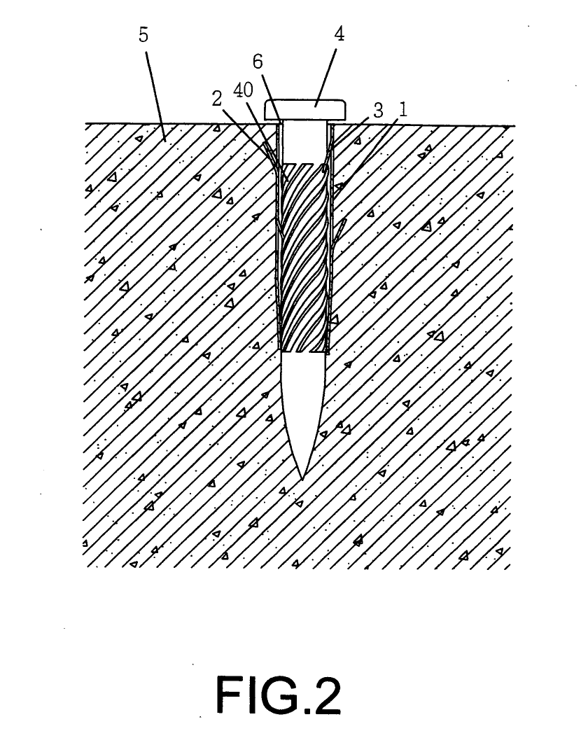

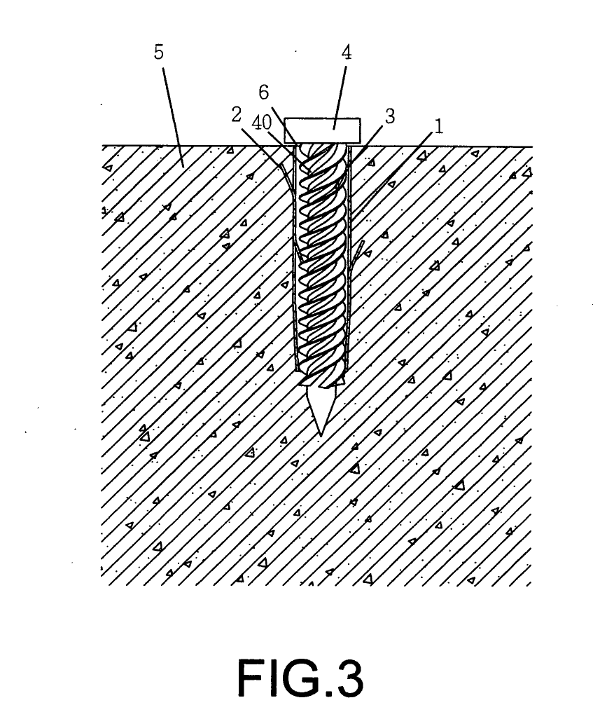

Referring to FIGS. 1-3, the invention provides a nail anchor for use with a wall nail 4 for nailing to a wall of a building construction/construction material 5. The wall nail 4 has a spiral groove 40 spirally extending around the periphery thereof.

The nail anchor of the invention comprises a tubular body 1 having a tapered end portion 11 that reduces gradually toward the bottom end thereof and a longitudinal split 10 longitudinally extending through, the top and bottom ends thereof, a plurality of teeth 2 obliquely upwardly and outwardly extended from the periphery of the tubular body 1 and a plurality of barbed portions 3 obliquely downwardly and inwardly extended from the periphery of the tubular body 1.

During application of the present invention, insert the tapered end portion 11 of the tubular body 1 of the nail anchor into a mounting hole 6 in the wall of the building construction/construction material 5 or sleeve the tubular body 1 wall nail 4 and then insert the pointed front tip of the wall nail 4 into the mounting hole 6 in the wall of the building construction/construction material 5, and then drive the wall nail 4 and the nail anchor into the inside of the mounting hole 6 in the wall of the building construction/construction material 5. When the wall nail 4 and the nail anchor are driven into the inside of the mounting hole 6 in the wall of the building construction/construction material 5, the teeth 2 are engaged into the periphery of the mounting hole 6 in the wall of the building construction/construction material 5 to prohibit the nail anchor from a backward displacement relative to the building construction/construction material 5, and the barbed portions 3 are engaged into the spiral groove 40 of the wall nail 4 to prohibit the wall nail 4 from a backward displacement relative to the nail anchor. Thus, the wall nail 4 is fixedly secured to the wall of the building construction/construction material 5.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A nail anchor for use with a wall nail having a spiral groove spirally extending around the periphery thereof for nailing to a wall of an object, said nail anchor comprising a tubular body, said tubular body having a tapered end portion at a bottom end thereof and a longitudinal split longitudinally extending through top and bottom ends thereof, a plurality of teeth obliquely upwardly and outwardly extended from the periphery of said tubular body and a plurality of barbed portions obliquely downwardly and inwardly extended from the periphery of said tubular body.
